(19) United States
(12) Patent Application Publication
(10) Pub. No.: US 2012/0069172 A1
(43) Pub. Date: Mar. 22, 2012

(54) CAMERA-BASED PIPELINE INSPECTION SYSTEM

(75) Inventor: Marcus Hudritsch, Sutz-Lattrigen (CH)

(73) Assignee: CD Lab AG, Murten (CH)

(21) Appl. No.: 13/032,781

(22) Filed: Feb. 23, 2011

Related U.S. Application Data
(60) Provisional application No. 61/383,617, filed on Sep. 16, 2010.

(51) Int. Cl. H04N 7/18

(52) U.S. Cl. 348/84; 348/E07.085

(57) ABSTRACT

A camera head is provided that is adapted to interface with an existing host camera supported on an existing inspection vehicle of an analog-based pipeline inspection system. The camera head allows for capture, processing and storage of digital image data in a memory at the camera head. The camera head includes a digital-to-analog signal converter, and a control module causing selected images to be converted from digital format to analog format, and to be transmitted for navigation purposes via a conventional analog control cable to conventional analog video monitoring equipment in a conventional operator station. Digital Image and other data may be retrieved directly from the digital data memory of the camera head. This approach provides numerous advantages with respect to capture and review of images in digital format, while also permitting control of the vehicle for navigation purposes using an operator's existing analog-based monitoring and control equipment.

### CROSS-REFERENCE TO RELATED APPLICATION

This application claims the benefit of priority under 35 U.S.C. 119(e) of U.S. Provisional Patent Application No. 61/383,617, filed Sep. 16, 2010, the entire disclosure of which is hereby incorporated herein by reference.

### FIELD OF INVENTION

The present invention relates generally to camera-based imaging systems, and in particular relates to a pipeline inspection system including a vehicle-mounted digital camera-based imaging system.

### BACKGROUND

Various pipeline inspection systems are well-known in the art. There are at least two common forms of such systems, namely, those that rely upon analog video image technology, and those that rely upon sidescan digital still image technology.

Most systems in use today rely upon analog video image technology. An exemplary system is shown in FIG. 1. Such a system includes an analog video camera (b) mounted upon an electrically-powered motorized crawler (a). A cable (c) connects the crawler to control and video recording equipment, which is typically housed in a motor vehicle. The cable carries electrical power and control signals to the crawler and returns analog video signals to the recording equipment as the crawler navigates through pipes. The video signals (d) are also monitored by an operator in the vehicle, who controls the crawler and/or video camera.

Such video-based systems typically provide zoom, pan and tilt capability by providing a movable camera having a two-axis pan and tilt camera head, and a zoom lens. Such an approach has a couple of disadvantages. First, constructing a suitable water- and explosion-proof camera head is expensive. Second, a two-axis pan-and-tilt system is not intuitive because the image inverts when viewing to the side. An exemplary SuperVision™ camera crawler system having zoom, pan, tilt and lift capability is manufactured and/or sold by IPEK Spezial TV GmbH of Austia, and is shown in FIG. 2.

Typical of such analog video-based systems is that the analog video signal is typically stored on analog VHS video tapes. This technology is approximately 45 years old, and is objectionable because of its relatively low image quality and the difficulties in reviewing the video images that is inherent to use of VHS tapes. An alternative storage arrangement involves digitally capturing the analog vide signal and compressing and storing the data in accordance with a common encoding standard, such as MPEG2. Such digital recording with MPEG compression improves the reviewability of the images, but has other objectionable limitations. For example, resolution after digitalization is still relatively low, e.g., max. resolution of 720×568 pixels (PAL), still images taken from digitally recorded videos suffer from interlacing, in that odd and even lines of the image are not captured at the same time, and a relatively low standard frame rate of 25 frames per second (PAL) allows a long shutter speed for which a relatively low light power is sufficient, but contributes to undesirable motion blurring. Further, the digital video compression reduces the image quality, and is not well-suited to pipe inspection where much of the video image changes while the crawler is moving. Because the compression compress significantly redundant image information (due to significant changes from frame to frame) single image quality is reduced to achieve satisfactory compression, and that leads to the well-known block-like image artifacts. Further, on the Windows operating system manufactured and/or distributed by Microsoft Corp. of Redmond, Wash., only video clips compressed with MPEG1 can be played back without installing third party decoding components. This often is the reason why inspection videos are delivered in MPEG1 which has normally only half of the possible the resolution. Decompressing MPEG-2, MPEG-4 or MPEG4-AVC videos is a very complex task and there many reasons why the playback still doesn't work on customers PCs. Low resolution, interlacing, motion blur, and compression artifacts lead to a poor still image quality. Good image quality is only possible when the camera crawler is completely stopped.

Further problems associated with analog-video based inspection systems relate to driving and stopping an inspection vehicle during inspection. Driving during an inspection significantly decreases the image quality of the video and makes it almost entirely useless for later viewing or processing. The risk of missing pipeline damages increases with the increasing speed of the vehicle. Because most contractors are paid per meter of pipeline inspection they tend to drive the vehicle quickly. Stopping during an inspection for every potential point of interest increases inspection time. Panning and tilting the camera to the point of interest further increases the time for each stop. Thus, the operator tends to want a fast inspection to increase inspection profitability, while the pipeline owner tends to want a slow inspection to increase inspection information quality. This tension is inherent to the analog video inspection process. In addition, the final viewer of the inspection video is limited in his review by the operator's decisions of stopping or not stopping (to obtain adequate inspection data) during the inspection.

Relatively recently, systems including sidescan technology have been developed as an alternative to those systems that include analog video technology. Sidescan systems make use of a series of still images of an inner surface of a pipe rather than video images. These systems provide images that show the inner surface of the pipe unfolded as 2D images. FIG. 3 shows an exemplary sidescan image and its relation to an exemplary pipe surface.

Sidescan images are assembled from strips that are unfolded from rings out of images captured by a fisheye lens. An exemplary method for creating sidescan images was published in WIPO patent publication no. WO 01/92852 A1, the entire disclosure of which is hereby incorporated herein by reference. FIG. 4 is an excerpt from that publication, showing how a ring extracted from a fisheye image is unfolded and presented as a 2D image.

Relative to conventional analog-video based inspection, sidescan imaging has the following advantages: miniature sidescan images can be used to provide a simple overview of the inspection, and allow for fast navigation and preview of inspection data; precise measurements may be taken from the images, they provide an intuitive view of the pipe's condition; several sidescans of the same pipe can be compared and therefore be used for documenting a measurable change over time; sidescans can easily be combined and synchronized with their source front view images or with a video.

An exemplary sidescan based system is the Panoramo system, manufactured and/or sold by IBAK Helmut Hunger GmbH of Germany. This system uses digital sidescan images and permits a post-inspection viewer to examine images taken during inspection and yet look in any desired view direction. An exemplary version of the system takes one 185° fisheye image to the front and one to the back at locations spaced every five centimeters of crawler travel. Together these two images provide a full 360° view every 5 cm of the pipe. See FIG. 5. The post-inspection viewer has the full freedom to look in any desired view direction after the inspection. The Panoramo system stores the unfolded sidescan along with these front and back view images. To transfer these high quality images to the control unit a fiber optic cable is required. The manufacture of a sufficiently long fiber optic cable for a rough environment that can handle strong forces is a critical and expensive task, and thus is undesirable. This technology is discussed in EP patent Nos. EP1022553A2 and EP1488207A2, the entire disclosures of both of which are hereby incorporated herein by reference. The scan can be produced while driving forwards or backwards. The inspection speed is very high because no stops are necessary and because flash lighting allows a very short shutter time. The observation coding is done after the inspection by a specialist in the office. FIG. 6 is an excerpt from IBAK Patent Publication No. WO03083430A2 showing periodic view points. View points in between are interpolated. However, during an inspection, the operator sees only the current front and back view image but not a live video preview.

Another exemplary sidescan system is the DigiSewer system manufactured and/or sold by iPEK Spezial TV GesmbH of Austria. This system is somewhat similar to the OYO system described above. The DigiSewer system periodically stores fisheye images from an analog video stream along with sidescan images. During an inspection, the operator sees the live video preview to the front. The scan is produced only while driving forward. The inspection speed is high because no stops are necessary. The observation coding is done after the inspection by a specialist in the office. The speed strongly influences the sharpness of the resulting sidescan, because the images are taken from the analog video with a constant frame rate of 25 fps. FIG. 7 shows motion blur images including motion blur resulting from sidescan images taken at 3 m/min, 6 m/min and 12 m/min vehicle speeds, due to a low shutter speed.

Yet another exemplary sidescan system is the RPP system manufactured and/or sold by RICO GmbH of Germany. This system has a dual-head camera that is a combination of a standard pan-and-tilt video camera and a fisheye scanning camera. With this system, a standard video inspection can be done while driving forwards. At the end of the section the scanning camera with a 190° fisheye lens is turned into the forward position. This dual head camera system is disclosed in WIPO patent application publication no. WO 04/113861 A1, the entire disclosure of which is hereby incorporated herein by reference. FIG. 8 shows a Rico RPP dual head inspection camera.

The RPP system stores the video images from the forward drive along with the sidescan from the backward direction. The synchronization between the video and the sidescan is done via a time/distance file that is written while capturing. During an inspection, the operator sees the live video preview from the pan-and-tilt camera. The inspection speed is relatively low because the operator stops the crawler for each observation, but the coding is done during the inspection.

Therefore, a system is needed that provides the advantages of high-resolution digital sidescan imaging, while also providing image feedback to the operator, at a relatively low cost. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present certain concepts of the invention in a simplified form as a prelude to the more detailed description that is presented later.

Generally, the present invention provides a novel camera head that can be retrofitted to an existing pipeline inspection vehicle, and used with a conventional analog-video-based inspection system (operator station, control cable, etc.) to provide an improved pipeline inspection system capable of performing high-speed inspections while providing high-quality inspection images. Thus, the camera head allows for upgrading of an analog pipeline inspection system while avoiding the need a new control cable, computer, or control unit. Conceptually, the camera head does so by employing digital imaging technology and digital data storage at the head, while using digital signal processing and a digital-to-analog signal converter at the head to send an analog video signal via a conventional (e.g., pre-existing) analog video cable back to the operator at the operator station for vehicle navigation purposes. Digital image data is retrieved directly from the camera head's memory, and is not transmitted back to the operator station via the conventional analog video cable. Further, use of a fisheye lens and software processing-based zoom, pan and tilt functions, avoids the need for articulatable mechanisms at the camera head, and greatly simplifies the camera head.

One aspect of the present invention provides a camera head for inspecting an inner surface of a pipeline. The camera head includes a housing supporting several components including: a digital image sensor configured to capture digital image data; a fisheye lens having a viewing angle greater than approximately 180 degrees, the fisheye lens being positioned to project images onto the digital image sensor; a memory for storing digital data; a digital signal processor configured to process digital image data received from the digital image sensor and store the processed digital image data in the memory; a digital-to-analog signal converter operatively connected to the digital signal processor to convert a received digital signal to an analog video signal; a control module configured to selectively send portions of the processed digital image data from the digital signal processor to the digital-to-analog signal converter; and a video port operatively connected to the digital-to-analog signal converter for transmitting the analog video signal from the digital-to-analog signal converter.

Another aspect of the present invention provides a camera-based pipeline inspection vehicle comprising a motor-driven carriage having a port configured to receive electrical power and control signals, and the above-referenced camera head supported on and operatively connected with the carriage to receive the electrical power and control signals.

Another aspect of the present invention provides a camera-based pipeline inspection system including the above-reference camera-based pipeline inspection vehicle, an operator station having a video monitor for viewing analog video signals transmitted from the vehicle, and a control cable connecting the vehicle and the operator station. The control cable is configured to carry the electrical power and control signals to the vehicle, and to further carry an analog video signal from the vehicle to the operator station.

Yet another aspect of the present invention provides a method for inspecting an inner surface of a pipeline. The method involves: providing a camera-based pipeline inspection system including a camera-based pipeline inspection vehicle coupled by a control cable to an operator station having a video monitor for viewing analog video signals transmitted from the vehicle via the control cable, the vehicle comprising a camera head; and causing the vehicle to traverse the pipeline. The method further involves, during the vehicle's traversing of the pipeline, the camera head: creating digital image data representing pipeline images projected via the fisheye lens; processing the digital image data to obtain inspection data; processing the digital image data to obtain navigation data; storing the digital inspection data in a memory; converting the digital navigation data into an analog video signal; and transmitting the analog video signal to the operator station via the cable. The method further involves retrieving the digital inspection data from the memory, e.g., after the vehicle's traversing of the pipeline.

### BRIEF SUMMARY OF DRAWINGS

The present invention will now be described by way of example with reference to the following drawings in which:

FIG. 1 is a schematic view of an exemplary prior art pipeline inspection system using analog video technology;

FIG. 2 is a perspective view of an exemplary prior art camera crawler system having zoom, pan, tilt and lift capability;

FIG. 3 is an illustration of a sidescan image and its relationship to an exemplary pipe surface, consistent with the prior art;

FIG. 4 is an illustration showing how a ring extracted from a fisheye image is unfolded and presented as a 2D image consistent with the prior art;

FIG. 5 is an illustration of an exemplary sidescan based imaging system;

FIG. 6 is an illustration showing the periodic view points from an exemplary sidescan based imaging system;

FIG. 7 is an image showing exemplary motion blur in sidescan images taken by vehicles moving at 3 m/min, 6 m/min and 12 m/min, respectively;

FIG. 8 is a side view of a Rico RPP dual head inspection camera of the prior art;

FIG. 9 is a schematic view of a camera-based pipeline inspection system include a digital camber head, in accordance with an exemplary embodiment of the present invention;

FIG. 10 is an elevational view of the exemplary digital camera-based vehicle of FIG. 9, shown within an exemplary pipeline P;

FIG. 11 is a schematic view of the digital imaging camera head of the vehicle of FIG. 10; and

FIG. 12 is a flow diagram illustrating a method for inspecting an inner surface of a pipeline in accordance with an exemplary embodiment of the present invention.

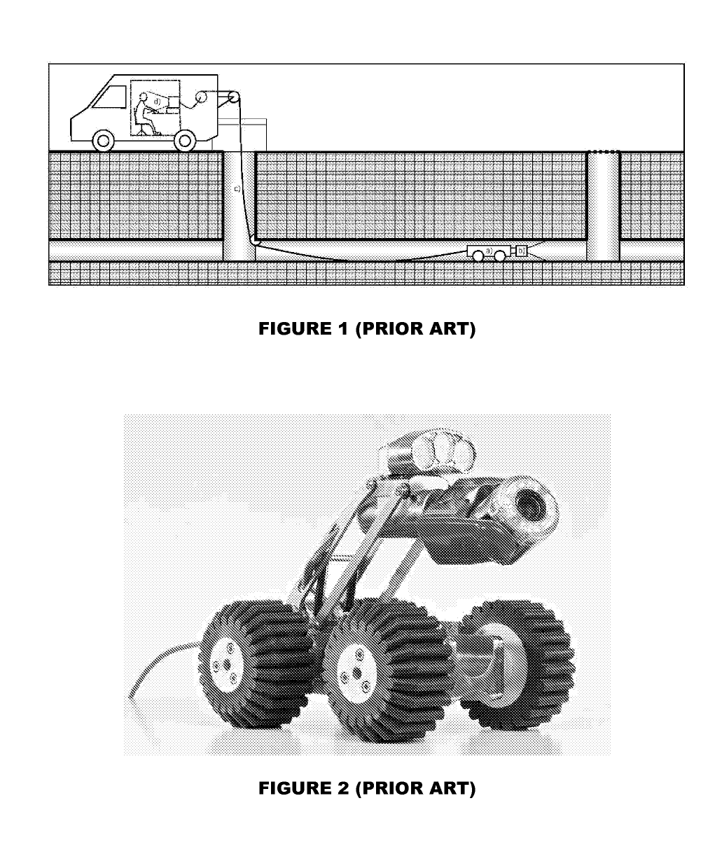

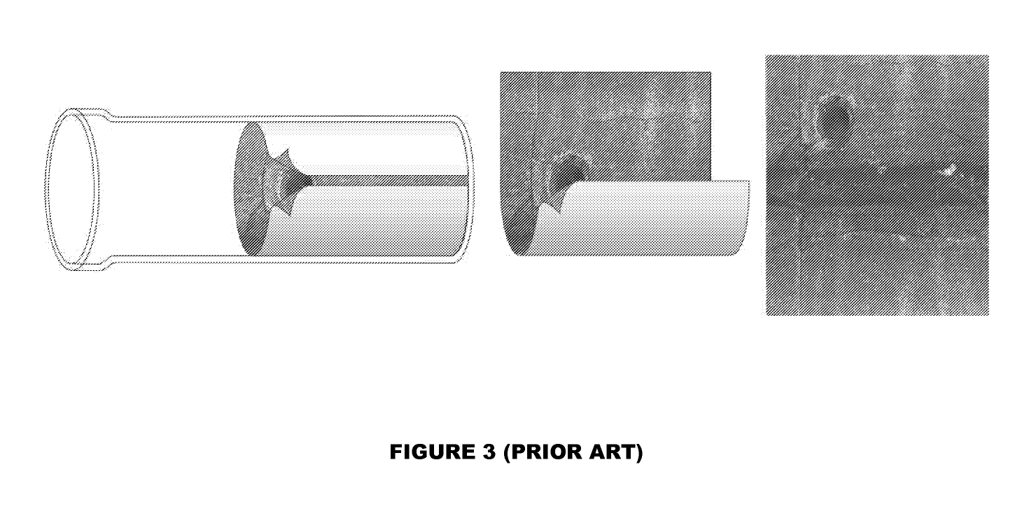

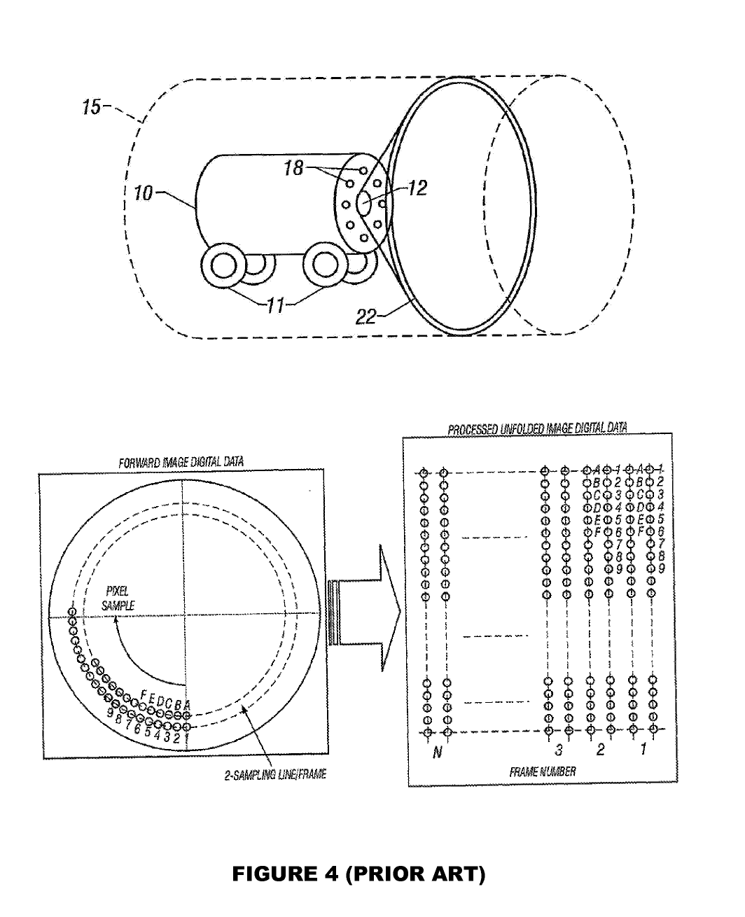

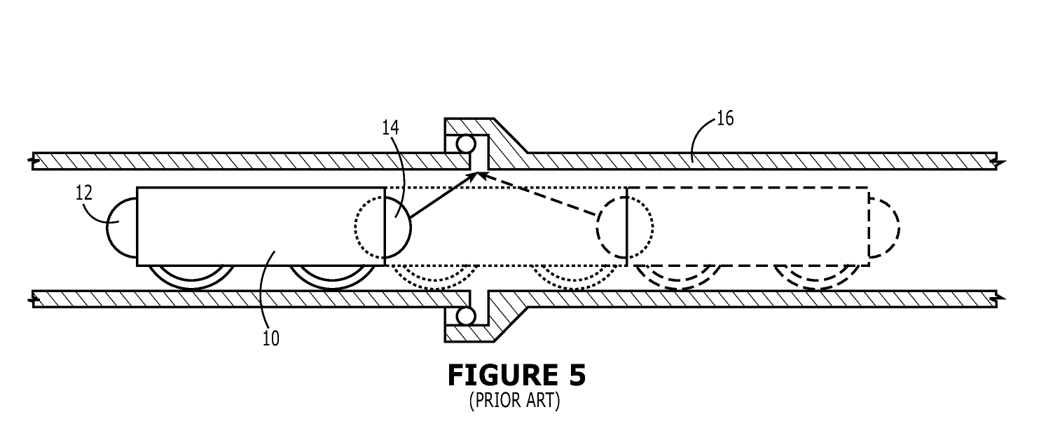

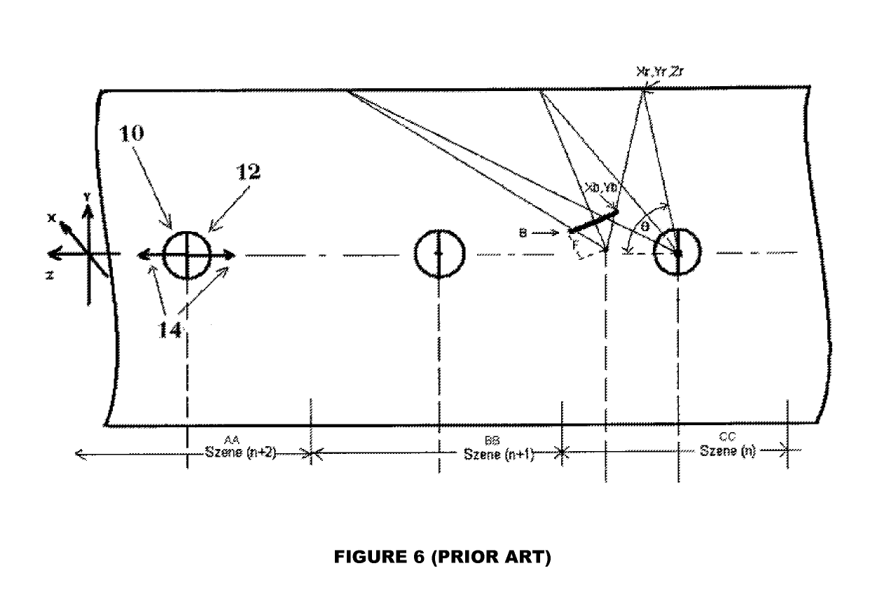

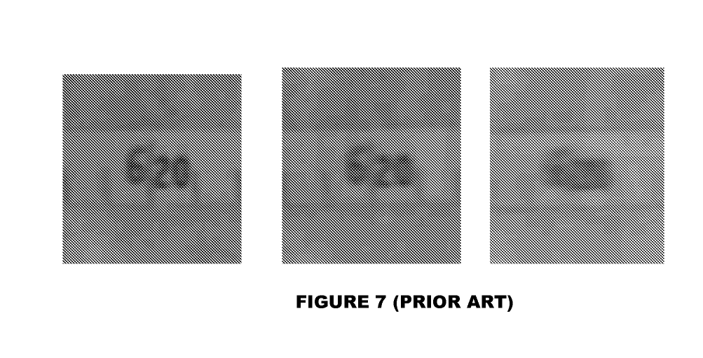

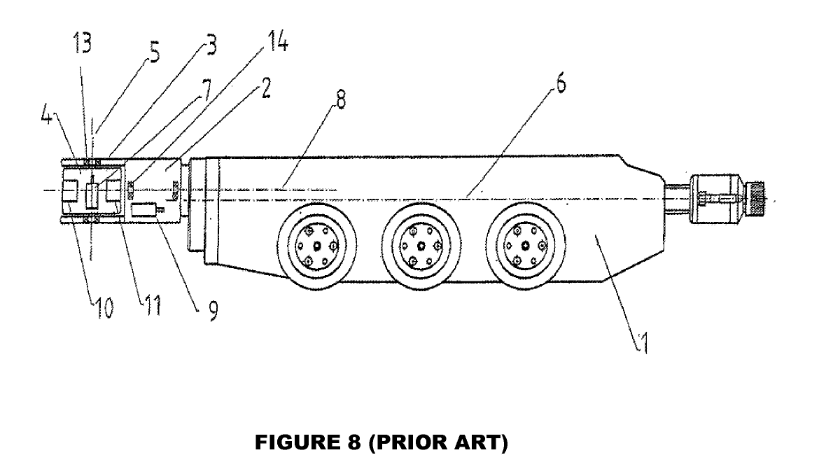

### DETAILED DESCRIPTION

The present invention relates to camera-based inspection apparatuses and methods for inspecting the interior surface of conduits, pipes, ducts, pipelines and other similar structures (collectively, “pipelines”) commonly used for transporting storm or sanitary sewage, air, liquids, gases, slurries and the like. In particular, the present invention provides a novel camera head that implements novel imaging technology, yet is compatible with many of the conventional camera-based pipeline inspection systems that are presently in use in the industry. Thus, the camera head is advantageous in that permits an operator having a conventional analog-based video inspection system including an analog-video-based inspection vehicle, and analog-video-based operator station and an analog video-based control cable to improve its imaging for inspection purposes by simply substituting the digital-image-based camera head of the present invention for the existing analog-image-based camera head of the operator's existing crawler-based inspection system. Despite the digital-based imaging system of the inventive camera head, the operator is permitted to continue to use its existing inspection vehicle, analog-video-based operator station, and analog-video-based control cable. Thus, an operator may upgrade his existing inspection system at relatively modest cost, while continuing to use what are typically the most expensive components of an inspection system, which are already in the operator's possession.

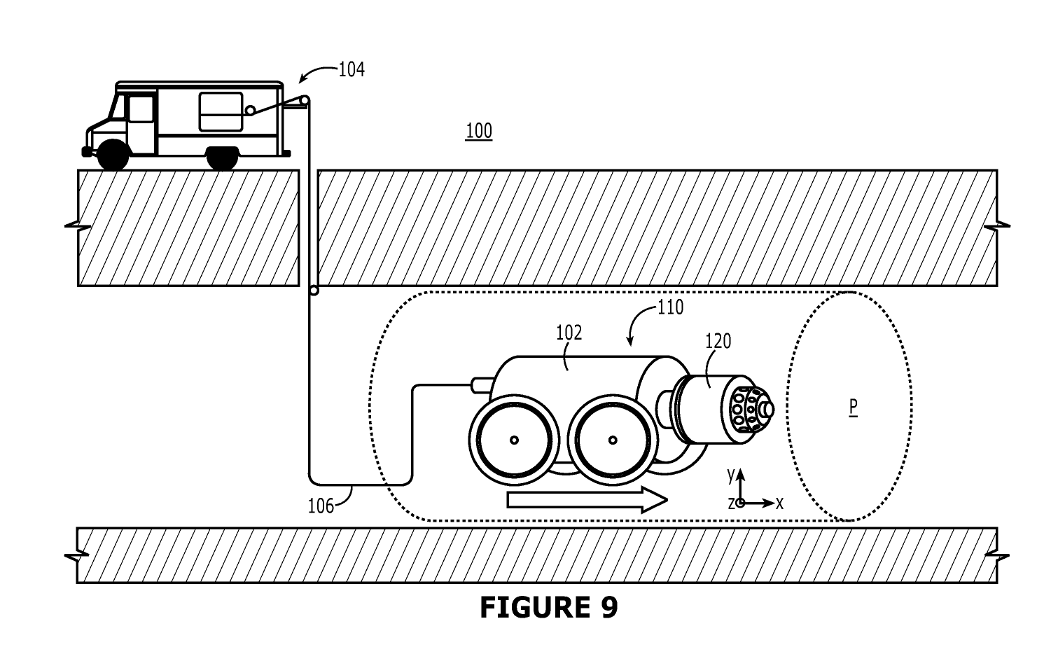

Referring now to FIG. 9, an exemplary camera-based pipeline inspection system 100 in accordance with the present invention is shown. The exemplary system 100 is somewhat similar to conventional analog-video-based pipeline inspection systems in that it includes a vehicle 110 including a conventional electrically-powered motorized carriage 102 connected to a conventional operator station 104 by a conventional control cable 106. Suitable motorized carriages generally include an electrically-powered, steerable and waterproof vehicle that is configured to support a camera in a central portion of the pipe, and are well known in the art. The SuperVision™ camera-based inspection system manufactured and/or sold by IPEK Spezial TV GmbH of Austria includes an exemplary motorized carriage 102. Any suitable carriage may be used. The operator station may include equipment for controlling the carriage and monitoring and recording video signals sent to the operator station 104 from the carriage 102, as well known in the art. Most commercially available systems include a control unit which can be coupled to a computer for digital video recording and data collection. Any suitable operator station may be used. All such equipment may be housed in a motor vehicle, as well known in the art. The control cable 106 is also conventional. The cable carries electrical power and control signals to the carriage 102 from the operator station 104, as known in the art. Further, the cable is adapted to carry analog video signals to the operation station 103, as known in the art. Suitable control cables are manufactured are commercially available from specialized cable manufacturers. Any suitable control cable may be used.

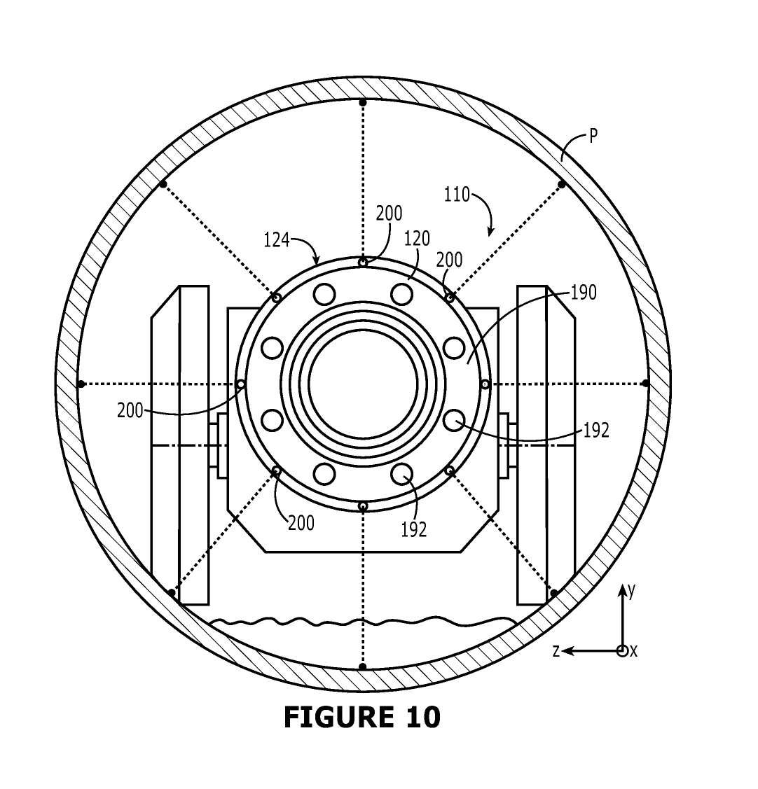

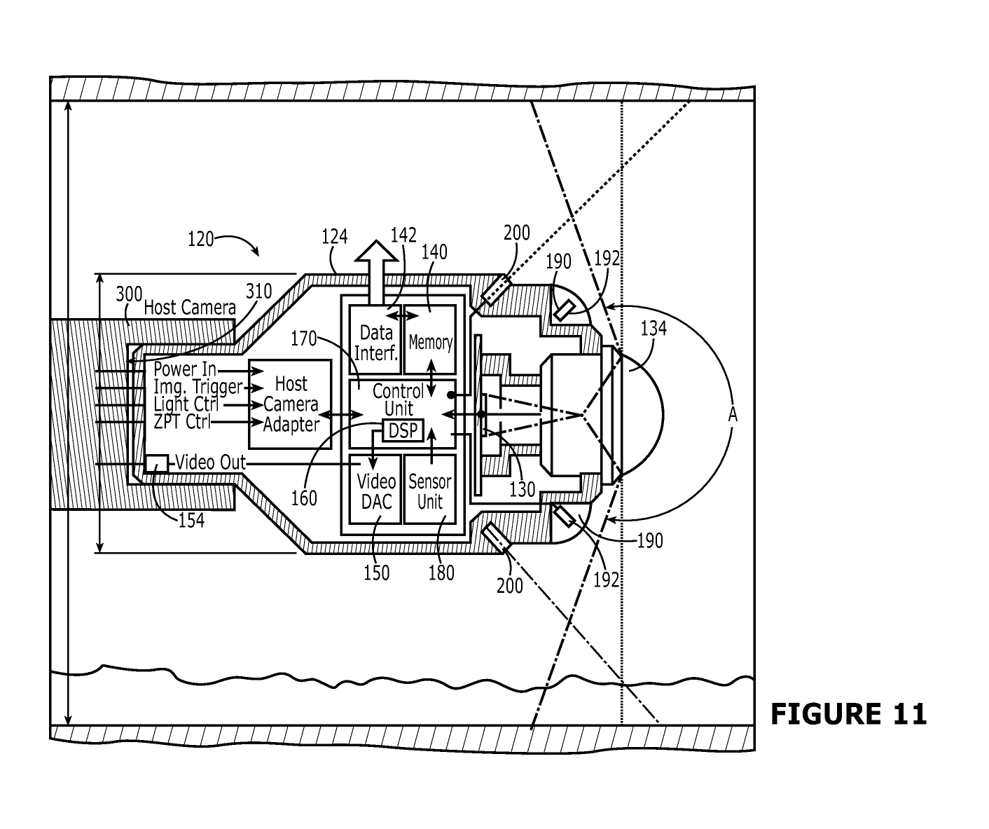

In accordance with the present invention, however, the vehicle 110 does not include a conventional analog-video-based camera head on the carriage 102, but rather includes a novel camera head 120 in accordance with the present invention. FIG. 10 shows a front view of an exemplary vehicle 110 with reference to an exemplary pipeline P. FIG. 11 is a schematic view of a camera head 120 for inspecting an inner surface of a pipeline in accordance with the present invention. Referring now to FIGS. 10 and 11, the camera head includes an outer housing 124 supporting the various components of the camera head 120. The housing may be made of any suitable material, as known in the art, but is preferably essentially cylindrical in overall shape with a major diameter of approximately 13 cm or less to allow for inspections of pipelines having an internal diameter as small as approximately 15 cm, as is common.

The housing 124 supports a digital image sensor 130 configured to capture digital image data. By way of example the digital image sensor 130 may be a progressive (full frame) CMOS or CCD image sensor chip capable of capturing focused still images with a resolution of 1000-1500 lines in height.

The housing 124 further supports a fisheye lens 134 having a viewing angle A (see FIG. 10) greater than 180 degrees. Many suitable fisheye lenses are commercially-available. As is typical, such a lens has a fixed focal length, and no zoom capability. The fisheye lens 134 is positioned on the housing 134 in relation to the digital image sensor so as to be in position to capture pipeline images during the inspection process, and to project the full view circle of the fisheye images onto the digital image sensor 130. Preferably, the fisheye lens has a viewing angle A falling in the range of 180 degrees to 190 degrees, and most preferably falling in the range of 190 degrees to 220 degrees. The lens and its mounting to the housing 124 are preferably waterproof or water-resistant so as to prohibit entry of pipeline liquids into the housing during a typical inspection process.

The camera head 120 further includes several electronic components operatively coupled to for communication therebetween. For example, the head 120 includes a memory for storing digital data 140. The memory may be any suitable memory for storing digital data. By way of example, the memory may include flash memory integrated on a printed circuit board, or a removable memory card such as a CF, SD, MMC or other memory card. Such memory is commercially available. For example, 32 GB of flash memory is sufficient for inspecting 5 km of pipeline inspection data for 1040×1040 pixel images taken every 5 cm of pipeline and stored with low JPEG compression.

The camera head further includes a data interface 142 for retrieving data stored in the memory. The data interface may have any suitable form. In embodiments in which the memory is provided as a chip fixed to a circuit board, the interface is provided as a digital data port supported on the housing, such as a conventional USB or ethernet LAN port or wireless WLAN, such that the data may be retrieved by a personal computer or other computing device. In embodiments in which the memory is provided as a conventional removable memory card, the data interface 142 is provided as a conventional memory card socket, such as a CF card socket, such that the memory card can be physically removed from the camera head 120 and placed in a memory card reader of another computing device to permit retrieval of the data by a personal computer, etc. Further, the camera head 120 includes a digital-to-analog converter 150. The digital-to-analog converter is specially-configured to receive a digital signal and convert it to an analog video signal. Specifically, the digital-to-analog converter is configured to convert digital image data into an analog video signal in one of a PAL format and an NTSC format, so that is it viewable via the conventional analog viewing equipment of the operator station 104.

Suitable conventional digital-to-analog converters are commercially available, and any suitable digital-to-analog converter may be used. The camera head 120 further includes a video port 154 operatively connected to the digital-to-analog converter 150 for transmitting the analog video signal from the digital-to-analog signal converter to the operator station, e.g., via the control cable, as discussed below. Any suitable video port may be used for this purpose.

The camera head further includes a processing unit 160 configured to process digital image data received from the digital image sensor 130. The processing unit may be a Digital Signal Processor (DSP) or may be a Field-Programmable Gate Array (FPGA) operatively connected on a printed circuit board. Processing is performed for multiple reasons.

First, all captured digital image data is processed for antidistortion purposes, i.e., to create an undistorted two-dimensional image from the distorted image projected by the fisheye lens onto the digital image sensor as a result of the geometry of the lens. Certain ones of these undistorted images are transmitted to an operator controlling the carriage for navigation purposes.

Second, the raw incoming images are compressed and prepared for storage as conventional image data files. This may be performed at regular intervals of time or distance, e.g. every 5 cm of vehicle travel. Standard image compression algorithms such as for the JPEG format may be applied. For example, JPEG compression technology may be used to prepare a *.jpg image file.

The processing unit 160 is also configured to selectively store and/or communicate processed image data, as discussed below. More specifically, the processing unit 160 is configured to store processed image data in the memory 140, and to transmit processed image data to the digital-to-analog signal processor 150. The unit 160 selectively stores and communicates processed image data under the control of a control unit, as discussed below. The control unit implements novel control functionality consistent with the present invention.

Hardware for performing digital signal processing for antidistortion and compression purposes, such as the DaVinci family of DSPs manufactured and/or sold by Texas Instruments, Inc. of Dallas, Tex., are commercially available, and any suitable DSP may be used.

The camera head 160 further includes a control module 170 that controls operation of the components discussed above, and the camera head as a whole, in accordance with the present invention. By way of the example, the control module 170 may be provided as a DSP or FPGA that is specially-programmed in accordance with the present invention.

The control module 170 performs several functions, and is operatively connected to multiple components of the camera head. First, it is noted that the control module 170 is operatively connected to the memory 140, the digital image sensor 130 and the digital-to-analog converter 150 and the processing unit 160. When the control unit 170 sends an appropriate control signal to the processing unit 160, the processing unit captures digital image data representing the pipeline image then focused by the fisheye lens 134 onto the digital image sensor 130. When the control unit 170 sends an appropriate control signal to the processing unit, the processing unit 160 processes inspection image data and stores it in the memory 140. Further, when the control unit 170 sends an appropriate control signal to the processing unit, the processing unit 160 processes navigation image data and transmits it to the digital-to-analog converter 150. Accordingly, the control module 170 is configured to selectively send portions of the processed digital image data from the processing unit to the digital-to-analog signal converter. Any suitable methodology may be used to determine when each type of control signal will be sent to the processing unit. Exemplary methodology is discussed below.

The exemplary camera head 120 of FIGS. 9 and 10 further includes an orientation sensor 180 supported on the housing 124. The orientation sensor 180 is configured to obtain and store in the memory 140 digital data reflecting an inclination angle, roll angle and yaw angle of the vehicle. The control module 170 communicates with the orientation sensor to cause the sensor 180 to capture and/or store orientation data in the memory 140 at or near the time of capturing of digital image data, such that a set of such data corresponds to each captured and stored pipeline inspection image. Various orientation sensors are commercially available, and any suitable orientation sensor may be used.

The exemplary camera head 120 of FIGS. 9 and 10 further includes an illumination unit 190 supported on the housing 124. The illumination unit includes light sources suitable for illuminating the pipeline to provide adequate illumination for taking of a photographic image of the interior surface of the pipeline. In a preferred embodiment, the light sources are provided as a plurality of LEDs 192 that are supported on the housing 124 in locations spaced (e.g., every 30 degrees) around a 360 degree periphery of the fisheye lens 134, as best shown in FIG. 13, to distribute illumination over the field of view. Suitable LEDs are commercially available, and any suitable LED or other light source may be used. The illumination unit is operatively connected in communication with the control module 170 so that the control module can selectively power on and power off the illumination unit 190 for the purposes described below.

The exemplary camera head 120 of FIGS. 9 and 10 further includes a plurality of laser ray light sources 200 supported on the housing 124. Each laser ray light source is suitable for providing a visually perceptible “dot” on the interior surface of the pipeline, such that the dots may be photographed and used as reference points for subsequent pipeline measurement purposes, in a manner well-known in the art. Suitable laser light sources are commercially available, and any suitable light source may be used. In a preferred embodiment, the laser light sources 200 are supported on the housing 124 in locations spaced (e.g., every 15 degrees) around a periphery of the fisheye lens 134, as best shown in FIG. 13. The laser light sources 200 are operatively connected in communication with the control module 170 so that the control module can selectively power on and power off the laser light sources 200 for the purposes described below.

The exemplary camera head 120 of FIGS. 9 and 10 further includes a host camera adapter 210. The host camera adapter 210 is configured to mate with a host camera interface 310 of the host camera 300, which may be part of an existing pipeline inspection vehicle. Accordingly, the camera head 120 may be configured to mate with, both physically and electronically, the host camera interface 310 of a conventional host camera, and may simply be exchanged for an original camera head of the host camera. In this exemplary embodiment, the host camera adapter 210 is configured to receive at least a power signal and a trigger signal from the host camera 300, via the host camera interface 310. The signals are received by the host camera via the control cable 106, and transmitted to the camera head via the host camera interface in a conventional manner. As is typical, the adapter 210 may also receive analog lighting control and zoom-pan-tilt control signals. These signals, along with the analog trigger signal, are converted to digital signals by the host camera adapter and transmitted to the control unit, which may reject them, or act in accordance with them, in accordance with programming in the control module.

In a certain embodiment, any zoom-pan-tilt control signals received at the host camera adapter 210 are used by the control unit to cause the DSP 170 to perform a “virtual” zoom, pan and/or tilt function by performing digital signal processing on the incoming image data received via the digital image sensor 130. By way of example, this processed image data, including any applied zoom, pan and/or tilt function, may be sent back to the operator for navigation purposes via the digital-to-analog signal converter 150.

In a preferred embodiment, the system includes a distance encoder that measures a distance traveled by the vehicle, e.g., by measuring an amount of control cable wound or unwound as the vehicle navigates this pipeline. As known in the art, this encoder on the cable wheel drum is used to issue a trigger signal which is received by the control module. For example, the encoder may be configured to generate 2000 electrical pulses per revolution. This electric signal is sent to the camera head, which interprets the pulses as distance, depending upon the encoder wheel diameter. The control module 170 in turn issues its own trigger signals to the processing unit, etc. For example, the encoder may send 200 pulses per 200 mm of encoder wheel circumference to the control module 170, the control module may issue control signals causing the processing unit 160 to capture digital image inspection data and store it in the memory 140 at points located every 5 cm along a path of travel. Further, the control module 170 may issue control signals causing the processing unit to capture digital image navigation data and send it to the digital-to-analog signal converter 150 at another interval, e.g., every 5 cm but out of phase with the images captured for inspection purposes, or as a function of time, e.g. ten times per second.

In a preferred embodiment, the control module 170 is configured to send control signals not only to the processing unit, but also to the illumination unit and the laser light sources, such that these components act in concert in accordance with the present invention. More specifically, the control module 170 is configured to initiate capture of images for inspection, navigation and measurement purposes.

To capture images for inspection purposes, the control module 170 sends a signal to the illumination unit 190 to power on the LEDs and illuminate the pipeline, then sends a control signal to the processing unit 160 to capture digital image data via the digital image sensor 130. The control module 170 then causes the captured digital image data to be stored in the memory 140. Optionally, the control module may cause orientation data from the orientation sensor 180 to be stored in the memory 140 also, in association with the image data. Optionally, the control module 170 may also send a signal to power off the illumination unit 190 after image capture is complete. Thus, the control module 170 causes the camera head to capture a photographic image under strobe lighting conditions, and to store such image data for inspection purposes.

To capture images for navigation purposes, the control module 170 sends a signal to the illumination unit 190 to power on the LEDs and also sends a control signal to the processing unit 160 to capture digital image data via the digital image sensor 130, as described above. However, these images need not be stored in the memory 140. The control module 170 causes the processing unit 160 to pass this captured image data to the digital-to-analog signal converter to create an analog video stream that can be monitored by an operator at the operator station 104, for navigation purposes. This image data may be processed, before transmission to the operator station 104, by the processing unit 160 to eliminate distortion caused by the fisheye lens, e.g., to provide an undistorted 2-D view for navigation purposes. Optionally, the control module 170 is configured to cause the processing unit to process and/or send to the digital-to-analog signal converter less than an entire fisheye lens image. For example, a narrower field of view of approximately 50 to 60 degrees may be deemed sufficient for navigation purposes. Optionally, the control module 170 sends a signal to power off the illumination unit 190. Thus, the control module 170 causes the camera head to capture a photographic image under strobe lighting conditions, and to pass such image data to the digital-to-analog signal converter for navigation purposes.

To capture images for measurement purposes, the control module 170 sends a signal to the illumination unit 190 to power off the LEDs (if they are not already powered off), sends a signal to the laser light sources 200 to power on the laser light sources, and also sends a control signal to the processing unit 160 to capture digital image data via the digital image sensor 130, as described above. The control module 170 then causes the digital image data to be stored in the memory 140. Optionally, the control module 170 sends a signal to power off the laser light sources 200. Thus, the control module 170 causes the camera head to capture a photographic image under ambient lighting (dark/unlit) conditions to provide an image showing reference points at which laser light impinges upon the inner surface of the pipeline. These images can be used to provide measurements with respect to the pipeline, in a conventional manner.

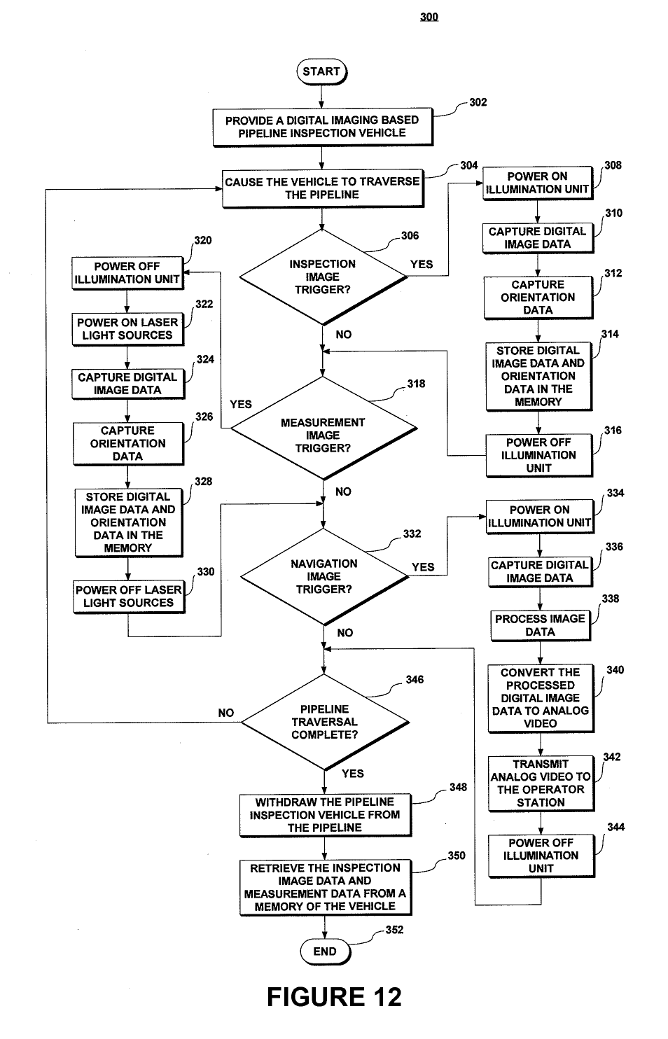

The pipeline inspection system described above may be used to inspect an inner surface of a pipeline in accordance with the method described below with reference to FIG. 12. Referring now to FIG. 12, the method 300 begins with providing a camera-based pipeline inspection system including a camera-based pipeline inspection vehicle coupled by a control cable to an operator station having a video monitor for viewing analog video signals transmitted from the vehicle via the control cable, as shown at step 302. This step includes providing a vehicle comprising a camera head having a housing supporting a digital image sensor configured to capture digital image data, a fisheye lens having a viewing angle greater than 180 degrees, said fisheye lens being positioned to project images onto said digital image sensor, a memory for storing digital data, a digital signal processor configured to process digital image data received from said image sensor and store said processed digital image data in said memory, a digital-to-analog signal converter operatively connected to said digital signal processor to receive a digital signal to be converted to an analog video signal, a control module configured to send portions of said processed digital image data from said digital signal processor to said digital-to-analog signal converter, and a video port supported on said housing and operatively connected to said digital-to-analog signal converter for transmitting the analog video signal from the digital-to-analog signal converter.

The method further includes causing the vehicle to traverse the pipeline, as shown at step 304. By way of example, this step may be performed in a conventional manner by providing operator input, e.g., via a joystick, at the operator's station 104 to control the vehicle via control signals transmitted from the operator's station via the control cable 106.

The method further includes the camera head 120 performing several steps during the vehicle's traversing of the pipeline. The steps include creating digital image data representing pipeline images projected on the digital image sensor via the fisheye lens. As shown at step 306, images captured for inspection purposes are captured in response to an inspection image trigger. By way of example, the inspection image trigger may be provided as a signal transmitted from an encoder as a function of the amount of control cable paid out as the vehicle traverses the pipeline, e.g. at intervals of 5 cm.

Referring now to FIGS. 11 and 12, if an inspection image trigger signal is received at step 306, the camera head 120, under the control of the control unit 170 powers on the illumination unit 190, as shown at step 308. This causes the pipeline to be adequately illuminated for inspection purposes. The control unit 170 then causes the digital image sensor 130 to capture digital image data as described above, as shown at step 310. The control unit 170 further causes the orientation sensor 180 to capture orientation data, and then store the digital image data and the orientation data in the memory 140 of the camera head 120, as shown at steps 312 and 314. It should be noted that as part of the capture and/or storing steps, the camera head's processing unit 160 may process the image data, e.g., to create a data file using JPEG compression. The control unit 170 may then power off the illumination unit as shown at step 316. This completes a single instance of an exemplary inspection image capture process. However, it should be noted that the inspection image capture process is repeated in response to each inspection image trigger, e.g., according to a signal transmitted at regular intervals during the vehicle's traversal of the pipeline.

The method further includes the camera head 120 creating digital image data representing pipeline images projected on the digital image sensor via the fisheye lens for pipeline measurement purposes. As shown at step 318, images captured for measurement purposes are captured in response to a measurement image trigger. By way of example, the measurement image trigger may be provided as a signal transmitted from an encoder as a function of the amount of control cable paid out as the vehicle traverses the pipeline, e.g. at intervals of 5 cm. These intervals are preferably spaced in time with respect to the capture of images for inspection data.

Referring now to FIGS. 11 and 12, if a measurement image trigger signal is received at step 318, the camera head 120, under the control of the control unit 170 powers off the illumination unit 190, as shown at step 320. This causes darkening (de-illumination) of the pipeline environment for the purpose of a capturing an image for measurement purposes. The control unit 170 then powers on the laser light sources 200 of the camera head 120, as shown at step 322. This causes beams of laser light to project from the camera head 120 and create visually perceptible “dots” (reference points) of laser light where the beams impinge upon the inner surface of the pipeline, as discussed above. The control unit 170 then causes the digital image sensor 130 to capture digital image data, and further causes the orientation sensor 180 to capture orientation data, and then store the digital image data and the orientation data in the memory 140 of the camera head 120, as shown at steps 324, 326 and 328. It should be noted that as part of the capture and/or storing steps, the camera head's processing unit 160 may process the image data, e.g., to create a data file using JPEG compression. The control unit 170 may then power off the laser light sources 200 as shown at step 330. This completes a single instance of an exemplary measurement image capture process. However, it should be noted that the measurement image capture process is repeated in response to each measurement image trigger, e.g., according to a signal transmitted at regular intervals during the vehicle's traversal of the pipeline.

The method further includes the camera head 120 creating digital image data representing pipeline images projected on the digital image sensor via the fisheye lens for pipeline navigation purposes. As shown at step 332, images captured for navigation purposes are captured in response to a navigation image trigger. By way of example, the navigation image trigger may be provided as a signal transmitted from an encoder as a function of the amount of control cable paid out as the vehicle traverses the pipeline, e.g. at intervals of 5 cm. Alternatively, this inspection image trigger signal may be provided by as a function of a time interval. These intervals are preferably spaced in time with respect to the capture of images for inspection and measurement data, and may be interleaved between consecutive image capture events for inspection purposes. Optionally, an image capture for inspection purposes may be processed and used for navigation purpose, but the navigation image capture process is discussed here as a separate function for illustrative purposes.

Referring now to FIGS. 11 and 12, if a navigation image trigger signal is received at step 332, the camera head 120, under the control of the control unit 170 powers on the illumination unit 190, as shown at step 334. This causes the pipeline to be adequately illuminated for navigation purposes. The control unit 170 then causes the digital image sensor 130 to capture digital image data, as shown at step 334. Optionally, the orientation sensor 180 may also capture orientation data at this time. Next, the control unit 170 causes the camera head's processing unit 160 to process the capture image data specifically for navigation purposes, as shown at step 338, e.g., to provide undistorted two-dimensional images facilitating an operator's navigation of the vehicle, to provide a limited view (less than the entire image capture) that is adequate for navigation purposes, to provide one of a zoom function, a pan function and/or a tilt function, etc. The processed digital image data is then converted to an analog video signal (e.g., in NTSC or PAL format), as shown at step 340. This step involves transmission of captured digital image data to the digital-to-analog signal converter 150 of the camera head, e.g. under the control of the control unit 170. As shown at step 342, the analog video signal is then transmitted to the conventional operator station 104, which includes conventional analog video monitoring equipment, via the conventional analog CCTV control cable 106. The operator may use the images in the analog video signal for the purpose of controlling the vehicle and causing it to navigate the pipeline. The control unit 170 may then power off the illumination unit 190 as shown at step 344. This completes a single instance of an exemplary navigation image capture process. However, it should be noted that the navigation image capture process is repeated in response to each navigation image trigger, e.g., according to a signal transmitted at regular intervals during the vehicle's traversal of the pipeline.

If the vehicle's traversal of the pipeline is not complete, the vehicle may be caused to continue to traverse the pipeline, as shown at steps 344 and 204, and image capture for inspection, measurement and navigation purposes may continue. However, if it is determined in step 344 that the vehicle's traversal of the pipeline has been completed, then the vehicle may be physically withdrawn from the pipeline, as shown at 346. In this exemplary embodiment, the inspection image data and measurement image data (and any associated orientation data) is then recovered from the memory of the vehicle, as shown at step 348, and the method ends, as shown at step 350. As discussed above, the data may be recovered from the memory 140 of the vehicle by transmitting it from the memory via a data interface port 142 of the camera head, or by physically removing the memory 140 (e.g., a CF memory card) from a port of the camera head 120 and inserting it in a suitable port of a PC, etc. In an alternative embodiment, the image data may be retrieved wirelessly from the vehicle's memory, and optionally prior to physical withdrawal of the vehicle from the pipeline.

Accordingly, it will be appreciated that, in accordance with the present invention, inspection and measurement image and other data is collected and stored digitally in the camera head, and then is retrieved directly from the camera head, while selected images are converted from digital format to analog format and transmitted via a conventional analog control cable to conventional analog video monitoring equipment in a conventional operator station for navigation purposes. This approach provides numerous advantages with respect to capture and review of images in digital format, while also permitting control of the vehicle for navigation purposes using an operator's existing analog-based monitoring and control equipment.

Accordingly, the present invention provides a novel camera head that can be retrofitted to an existing pipeline inspection vehicle, and used with a conventional analog-video-based inspection system (operator station, control cable, etc.) to provide an improved pipeline inspection system capable of performing high-speed inspections while providing high-quality inspection images. This allows for upgrading of an analog pipeline inspection system while avoiding the need a new control cable, computer, or control unit. Conceptually, the camera head does so by employing digital imaging technology and digital data storage at the head, while using digital signal processing and a digital-to-analog signal converter to send an analog video signal back to the operator at the operator station for vehicle navigation purposes. Digital image data is retrieved directly from the camera head's memory, and is not transmitted back to the operator station via the conventional analog control cable. Further, use of a fisheye lens, and software/processing-based zoom, pan and tilt functions, avoids the need for articulatable mechanisms at the camera head, and greatly simplifies the camera head.

While the present invention has been particularly shown and described with reference to the preferred mode as illustrated in the drawing, it will be understood by one skilled in the art that various changes in detail may be effected therein without departing from the spirit and scope of the invention as defined by the claims.

What is claimed is:

1. A camera head for inspecting an inner surface of a pipeline, the camera head comprising:
a housing, said housing supporting:
a digital image sensor configured to capture digital image data;
a fisheye lens having a viewing angle greater than 180 degrees, said fisheye lens being positioned to project images onto said digital image sensor;
a memory for storing digital data;
a processing unit configured to process digital image data received from said digital image sensor and store said processed digital image data in said memory;
a digital-to-analog signal converter operatively connected to said processing unit to convert a received digital signal to an analog video signal;
a control module configured to selectively send portions of said processed digital image data from said processing unit to said digital-to-analog signal converter; and
a video port operatively connected to said digital-to-analog signal converter for transmitting the analog video signal from the digital-to-analog signal converter.

2. The camera head of claim 1, further comprising a memory card socket, and wherein said memory comprises a memory card removably received in said memory card socket.

3. The camera head of claim 1, wherein said memory is fixed within said housing, said camera head further comprising a digital data port supported on said housing for transmitting digital image data stored in said memory.

4. The camera head of claim 1, further comprising:
an orientation sensor supported on said housing, said orientation sensor being configured to obtain and store in said memory inclination, roll and yaw angle data.

5. The camera head of claim 1, further comprising:
an illumination unit supported on said housing in communication with said control module, said control module being configured to selectively power said illumination unit.

6. The camera head of claim 5, wherein said illumination unit comprises a plurality of LEDs disposed in positions around said fisheye lens.

7. The camera head of claim 1, wherein said digital-to-analog signal converter is configured to convert digital image data into an analog video signal in one of a PAL format and an NTSC format.

8. The camera head of claim 1, said control module further comprising a host camera adapter, said host camera adapter being configured to receive at least a power signal and a trigger signal from a host camera, said control module being configured to power on said illumination unit and initiate digital image data capture by said digital image sensor in response to receipt of said trigger signal.

9. The camera head of claim 1, further comprising a plurality of laser light sources supported on said housing, said control module being configured to selectively power off said illumination unit, power on said plurality of laser light sources, and initiate digital image data capture by said digital image sensor.

10. A method for inspecting an inner surface of a pipeline, the method comprising:
providing a camera-based pipeline inspection system including a camera-based pipeline inspection vehicle coupled by a control cable to an operator station having a video monitor for viewing analog video signals transmitted from the vehicle via the control cable, the vehicle comprising a camera head:
causing the vehicle to traverse the pipeline;
during the vehicle's traversing of the pipeline, the camera head:
creating digital image data representing pipeline images projected via the fisheye lens;
processing the digital image data to obtain inspection data;
processing the digital image data to obtain navigation data;
storing the digital inspection data in a memory;
converting the digital navigation data into an analog video signal; and
transmitting the analog video signal to the operator station via the cable; and
after the vehicle's traversing of the pipeline, retrieving the digital inspection data from the memory.

11. The method of claim 10, wherein said creating digital image data comprises capturing data for inspection purposes by:
illuminating the pipeline;
triggering capture of digital image data.

12. The method of claim 11, wherein said creating digital image data further comprises capturing data for navigation purposes by:
illuminating the pipeline;
triggering capture of digital image data.

13. The method of claim 12, wherein said creating digital image data further comprises capturing data for measurement purposes by:
de-illumination the pipeline;
providing laser reference points on the pipeline;
triggering capture of digital image data.

14. The method of claim 13, wherein said capturing data for inspection purposes is performed at an interval, and wherein said capturing data for navigation purposes and said capturing data for measurement purposes are performed within the interval, intermediate capturing data for inspection purposes.

15. The method of claim 14, wherein the interval comprises an interval of distance traveled by the vehicle.

16. The method of claim 15, wherein said capturing data for navigation purposes is performed at an interval of time.

17. The method of claim 10, wherein processing the digital image data to obtain navigation data comprises processing the data to provide at least one of a zoom function, a pan function, and a tilt function.

18. The method of claim 10, wherein processing the digital image data to obtain navigation data comprises performing antidistortion processing to provide a two-dimensional perspective of an image.

19. The method of claim 10, wherein retrieving the digital inspection data from the memory comprises removing a removable memory card from the camera head.

20. The method of claim 10, wherein retrieving the digital inspection data from the memory comprises downloading processed digital image data from the memory of the camera head.

21. A method for inspecting an inner surface of a pipeline, the method comprising:
providing a camera-based pipeline inspection system including a camera-based pipeline inspection vehicle coupled by a control cable to an operator station having a video monitor for viewing analog video signals transmitted from the vehicle via the control cable, the vehicle comprising a camera head comprising:
a housing, said housing supporting:
a digital image sensor configured to capture digital image data;
a fisheye lens having a viewing angle greater than 180 degrees, said fisheye lens being positioned to project images onto said digital image sensor;
a memory for storing digital data;
a processing unit configured to process digital image data received from said image sensor and store said processed digital image data in said memory;
a digital-to-analog signal converter operatively connected to said processing unit to receive a digital signal to be converted to an analog video signal;
a control module configured to send portions of said processed digital image data from said processing unit to said digital-to-analog signal converter; and
a video port supported on said housing and operatively connected to said digital-to-analog signal converter for transmitting the analog video signal from the digital-to-analog signal converter; and
causing the vehicle to traverse the pipeline;
during the vehicle's traversing of the pipeline, the camera head:
creating digital image data representing pipeline images projected on the digital image sensor via the fisheye lens;
processing the digital image data at the processing unit to obtain inspection data;
processing the digital image data at the processing unit to obtain navigation data;
storing the digital inspection data in the memory;
converting the digital navigation data into an analog video signal at the digital-to-analog converter; and
transmitting the analog video signal to the operator station via the cable; and
after the vehicle's traversing of the pipeline, retrieving the digital inspection data from the memory.

22. A camera-based pipeline inspection vehicle comprising:
a motor-driven carriage having a port configured to receive electrical power and control signals; and
the camera head of claim 1 supported on and operatively connected with said carriage to receive the electrical power and control signals.

23. A camera-based pipeline inspection system comprising:
the camera-based pipeline inspection vehicle of claim 22;
an operator station having a video monitor for viewing analog video signals transmitted from said vehicle; and
a control cable connecting said vehicle and said operator station, said control cable being configured to carry the electrical power and control signals to said vehicle, and to further carry an analog video signal from said vehicle to said operator station.
